(19) United States
(12) Patent Application Publication
(10) Pub. No.: US 2015/0278724 A1
(43) Pub. Date: Oct. 1, 2015

(54) VARIABLE COLOR WIDGET AND MESSAGE PRESENTATION USER INTERFACE TO ENCOURAGE USERS TO CONSUME LESS PRINTING RESOURCES

(71) Applicant: XEROX CORPORATION, Norwalk, CT (US)

(72) Inventors: BIJENDER S. MALIK, WEBSTER, NY (US); BRIAN D. BACON, MACEDON, NY (US); FRITZ EBNER, PITTSFORD, NY (US); JUTTA K. WILLAMOWSKI, GRENOBLE (FR); KIRK POTHOS, WEBSTER, NY (US); DAVID CHARRUAU, GRENOBLE (FR); SHAUNA E. ORMON, ROCHESTER, NY (US); SALVATORE J. SACK, Jr., FAIRPORT, NY (US); DERRICK J. EBERHART, ROCHESTER, NY (US); CHRISTOPHER HODGE, SPENCERPORT, NY (US); YVES HOPPENOT, NOTRE DAME DE MESSAGE (FR)

(73) Assignee: XEROX CORPORATION, Norwalk, CT (US)

(21) Appl. No.: 14/228,498

(22) Filed: Mar. 28, 2014

(51) Int. Cl. G06Q 10/06; G06F 3/12

(52) U.S. Cl. CPC G06Q 10/0631; G06F 3/1218; G06F 3/1273

(57) ABSTRACT

Methods, systems, and devices automatically monitor printing activities of a user using a tangible processor, and automatically analyze the printing activities of the user to determine the printing history of the user over time using the tangible processor. Also, these methods, systems, and devices automatically compare the printing history with previously established printing data (using the tangible processor) to produce an analysis of user printing activity, and automatically change the appearance of a graphic screen item on a graphic user interface based on the analysis of the user printing activity. Further, these methods, systems, and devices display details of the analysis of user printing activity on the graphic user interface in response to user interaction with the graphic screen item.

### BACKGROUND

Systems and methods herein generally relate to printing devices and printing systems, and more particularly to printing devices and systems that use a variable color widget and message presentation user interface to encourage users to consume less printing resources.

Businesses consistently ask for help on reducing the cost of printing, as well as on reducing the amount of printing they do. Traditional accounting, authorization, and authentication systems provide mechanisms for this, but feedback from this and similar offerings indicates that users do not like to be given quotas, be restricted from a particular printing behavior, etc. Businesses are looking for ways to encourage their users to print less, in a way that is motivating and encouraging, not penalizing or draconian.

### SUMMARY

Exemplary methods, systems, and devices herein automatically monitor printing activities of a user using a tangible processor, and automatically analyze the printing activities of the user to generate the printing history of the user over time using the tangible processor. Also, these exemplary methods, systems, and devices automatically analyze the printing history of the user by comparing the printing history with previously established printing data (using the tangible processor) to produce an analysis of user printing activity, and automatically change the appearance (change the size, color, etc.) of a graphic screen item on a graphic user interface (that is operatively (meaning directly or indirectly) connected to the tangible processor) based on the analysis of the user printing activity. Further, these methods, systems, and devices display details of the analysis of user printing activity on the graphic user interface in response to user interaction with the graphic screen item.

When analyzing the printing history of the user, such methods, systems, and devices perform a number of processes. For example, these methods, systems, and devices identify alternative printing activities that are different from the printing activities of the user (but that produce the same (or identical) printed information as the printing activities of the user, because the alternative printing activities use a different type of printing or different type of output). Further, these methods, systems, and devices generate a user score for the printing activities of the user, and generate alternative printing option scores for the alternative printing activities, based on a scoring system corresponding to printer resource consumption.

Then, such methods, systems, and devices compare the user score with the alternative printing option scores to rank the alternative printing activities relative to the printing activities of the user, and to identify which of the alternative printing activities change the user score the greatest amount (in ranked order) and such alternative printing activities are referred to as substitute printing activities. Further, such methods, systems, and devices compare the user score to scores of peers of the user, to produce a peer comparison.

Also, when analyzing the printing history of the user, these methods, systems, and devices retrieve textural messages of explanation for the substitute printing activities (from the previously established printing data). The textural messages of explanation describe why using the substitute printing activities change the user score.

The graphic screen item remains constantly present on the graphic user interface, but the details of the analysis of user printing activity are displayed on the graphic user interface only upon the user interaction with the graphic screen item. Further, when displaying such details of the analysis of user printing activity on the graphic user interface (in response to user interaction with the graphic screen item) the methods, systems, and devices herein display the user score, the alternative printing option scores of the substitute printing activities in the ranked order, the textural messages, the peer comparison, etc.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a schematic diagram illustrating display features herein;

FIG. 2 is a schematic diagram illustrating display features herein;

FIG. 3 is a schematic diagram illustrating display features herein;

FIG. 4 is a schematic diagram illustrating display features herein;

FIG. 5 is a flow diagram of various methods herein;

FIG. 6 is a schematic diagram illustrating systems herein; and

FIG. 7 is a schematic diagram illustrating devices herein.

### DETAILED DESCRIPTION

As mentioned above, businesses are looking for ways to encourage their users to print less, in a way that is motivating and encouraging, and different from a “top down” approach that can be penalizing or draconian. An alternative to the traditional print governance top down approach to print reduction is addressed by the methods, systems, and devices herein provide user print awareness and use a variable color widget and message presentation to encourage users to consume less printing resources. Print awareness aims to teach the user how to print more responsibly, in conjunction with a business's print responsibly campaign. Print awareness has several features. The methods, systems, and devices herein use a scoring system (that can be presented to the user in the form of virtual printing currency, or other forms) to improve the environmental behavior within an organization, using an overall feature set of the user interface components and underlying business rules.

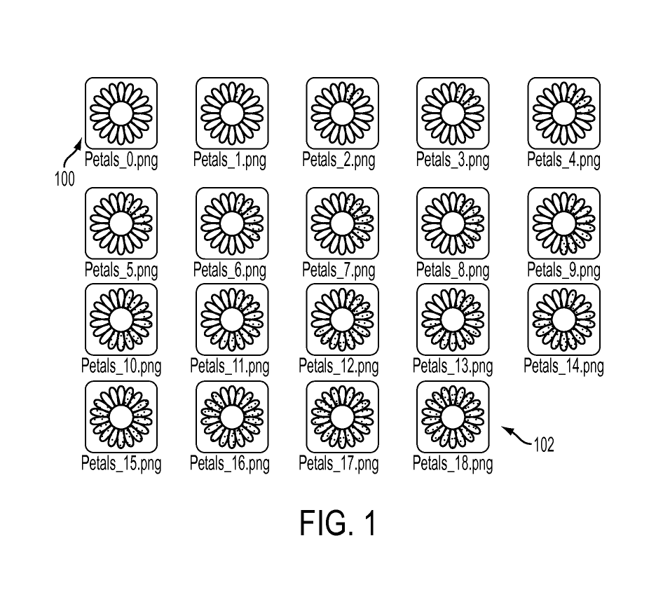

In one example of methods, systems, and devices herein, print awareness is exposed to users through a windows desktop widget that, in its closed form, sits on the desktop of the user's computerized device and displays a graphic item (widget, icon, button, etc.) such as a flower, tree, circle, sun, ball, diamond, or any other representative shape, etc. For example, the petals of a graphic flower can change color from a pleasant color (such as green, yellow, orange, etc.) to a less vibrant color (e.g., gray, black, etc.) as the user becomes less efficient in their printing over a specific time period (e.g., over a week, month, quarter, year, etc.). FIG. 1 illustrates an exemplary graphic item changing color, where the top left widget 100 is fully white (background color) and (progressing line by line from left to right and top to bottom) transitions to fully color at the bottom right 102. Each different colored image in FIG. 1 represents a different score or trend of the user's printing resource utilization efficiency.

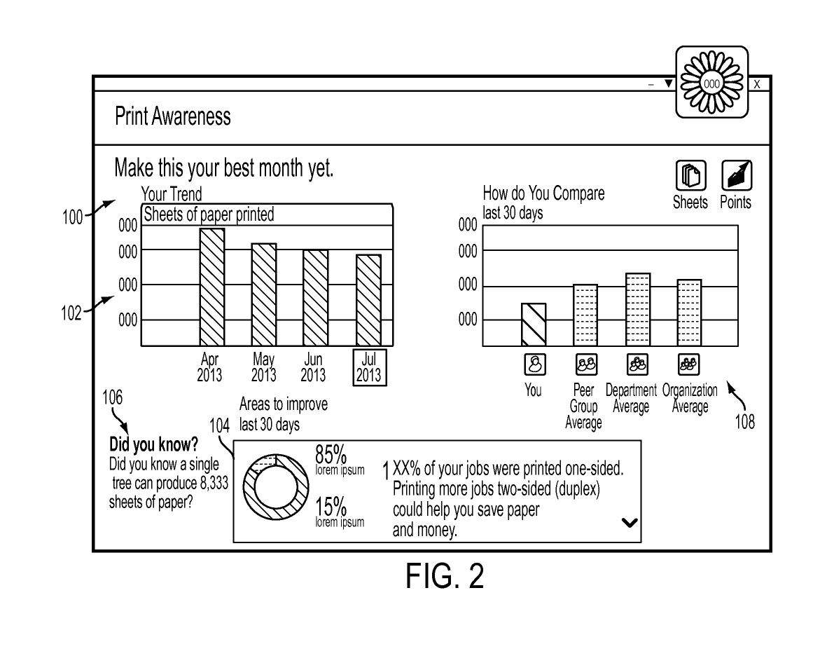

When the widget is opened (by the user moving and/or activating (e.g., clicking) a pointing device of the graphic user interface to select or activate the widget), the user is presented with many pieces of information, such as those shown in the screenshots illustrated in FIGS. 2-4. Some of the information presented can include a high level dynamic textual message, such as “how are you doing?” In one example, such high level textual messages can change over the course of the time period. For example, the high level textual message can dynamically change from “make this your best month yet” (item 100, FIGS. 2-4) which can be displayed on days 1-5 of every month, “keep it up, you're doing great,” shown if user is at or better than goal, “you're doing well . . . but you could do better,” shown if at or better than budget, and “examine your printing habits for areas to improve” (items 104 and 114, FIGS. 2-4) if worse than budget, etc.

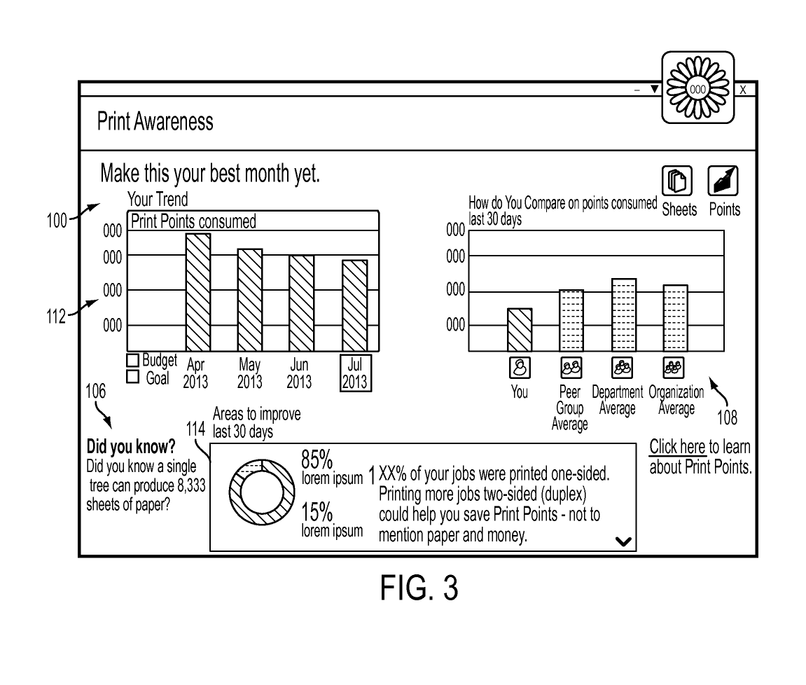

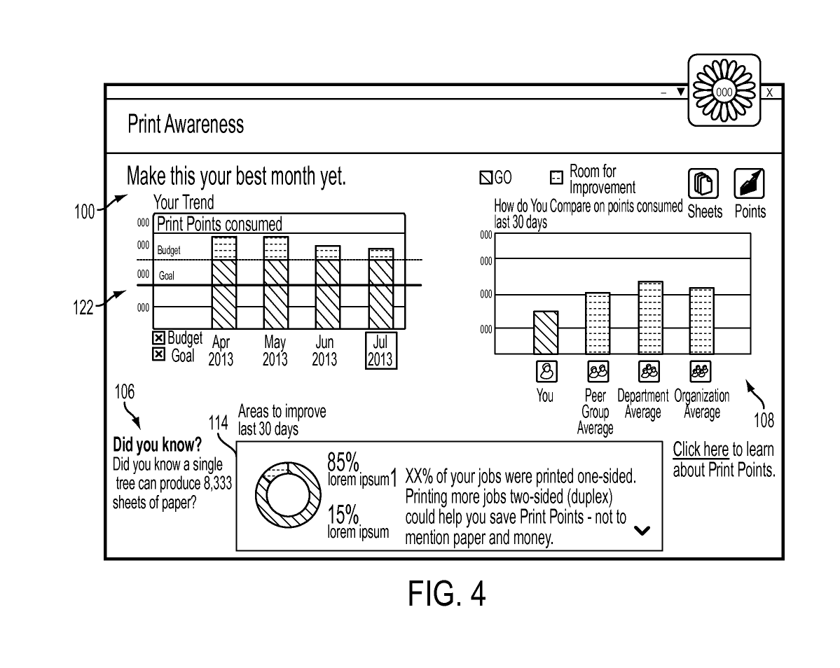

Further, activation of the widget can present information, such as performance over time, e.g., monthly “your print history” print trend (shown in a “sheets” view (item 102, FIG. 2) and a “points” view (items 112 and 122 in FIGS. 3 and 4)). 2). In item 122 in FIG. 4, a budget line is included to visually compare users history to their budget (also called quota, which can be based on their historical points consumption). Thus, in the “points” view, shown for example in FIG. 4, in item 122 the user is shown their budget line (which can be based on their historical average) and a goal line, which is a reduction % set by the business account administration. In this way, the business goals are connected with individual users' goals and behaviors.

The scoring for a user's printing activity can be counted in points or printing currency, for example. Thus, a user's specific print history is used by methods, systems, and devices herein to calculate cost “points” for print behaviors (e.g. simplex, color, reprint, long documents, etc., are assessed extra points). User's specific print history is recorded by a job tracking agent (either local to the computer operated by the user, or centrally located), then cost points are calculated based on the cost parameter settings and such are synchronized with the cost calculation module. For example, e-mail printing can be assigned of very high cost score (10 points per page); web printing can be assigned a lower cost score (3 points per page); double-sided printing can be assigned relatively lower scores (1 point per page); etc. Total consumption is the sum of cost elements of individual print jobs.

As shown in item 108 in FIGS. 2-4, the information presented can also include a comparison with peers, such as the illustrated comparison chart between the user, the organization, the department, and the user's peer group. Users can select the peer group (occupational role), and department they belong to, and can change it at any time (if they change jobs, for example).

Further, this information presented can provide a set of print tips with associated variable data and graphs (items 104, 106, and 114 in FIGS. 2-4). Specifically, methods, systems, and devices herein rank the consumption “points” of the print behaviors and present the print improvement tips that were ranked highest. The improvement tips 104, 106, 114 connect the user's behavior with the account's specific print reduction goals, and the prioritization through ranking ensures that the user is always displayed the most important and relevant feedback.

Additionally, a relative importance metric can be used to calculate the user's score. The relative importance metric can be computed for a cost element according to business account print reduction goals that are established when the system is deployed. In an exemplary point calculation, I=C/M, where I is importance, C is cost of a given element, and M is the maximum cost of the elements under consideration.

For example, the business can select the following alternative importance relevance settings for different types of printing activities: a) no penalty points and no points cost; b) some penalty points (e.g., 10 points/job); c) a higher level of penalty points (e.g., 1 point/sheet); and d) maximum penalty points (e.g., 2 points/sheet). These settings are meant to simplify the administration of the account (trading off flexibility).

In another example, elements used to assess point costs can include overall sheet volume printed, color cost, simplex cost, reprint cost, long document cost, email cost, web browser print cost, etc. Additional point cost elements can be added, e.g. toner coverage, copies, banner pages, etc.

Specific examples of helpful messages that can raise user awareness and provide user motivation can include:

“Remember to print 2-sided. You printed 7 single-sided jobs in the last 30 days. You could have saved 35 points by printing 2-sided.” Accompanied by a graphic that shows a donut chart where color represents duplex sheet count, and gray represents simplex sheet count and has text saying “1-sided sheets”, “2-sided sheets”;

“56% of your pages were printed in color in the last 30 days. If you can print less color, you can save the company some green, and yourself some points.” Accompanied by a graphic that shows a donut chart where color represents mono page %, gray represents color page %, and has text saying “black and white”, “color”;

“Print only the pages you need. 15% of your print jobs were greater than 20 sheets of paper. Try printing only the page range you need instead of the entire document.” Accompanied by a graphic that shows a donut chart where color represents % non-long docs, gray represents long document job %.” With gray % text saying “% long docs”;

“Consider proof reading before printing to prevent wasted paper. You re-printed documents 5 times in the last 30 days.” Accompanied by a graphic that shows a donut chart where color represents the number of not-reprinted documents, and gray represents the number of jobs that were reprinted;

“Did you know company printing policy discourages printing of email? You printed 35 sheets of paper from email, costing you 70 points.” Accompanied by a graphic that shows a donut chart where color represents sheets of paper of non-email print. Gray is labeled “email sheets” and represents sheets of paper of email print;

“The company printing policy discourages printing web pages. You printed 23 sheets of paper from the web, costing you 46 points.” Accompanied by a graphic that shows a donut chart where color represents sheets of paper of non-web print. Gray is labeled “web sheets” and represents sheets of paper of web print;

“You are printing a lot lately. You've printed 56 sheets more than your historical average in the last 30 days”; etc.

These tips are ranked and presented to the user in order. In one example, if the total sheets printed in the last 30 days exceeds the “sheets budget,” or historical volume of sheets, then this tip will always be ranked first, otherwise the tip is not shown.

The output can include topical information to provide emotional hooks for maintaining interest, such as a set of eco-tips that present informational text 106, which can be updated from a feed from a server. Such eco-tips can be stored on a print awareness server and requested by the client every 1 minute. Extensions allow custom tips to be created at an account. Examples of eco-tips include: “Did you know a single tree can produce 8,333 sheets of paper?”; “Did you know a ream of paper (500 sheets) uses 6% of a tree (and those add up quickly)?”; “Did you know the average car emits over 11,000 pounds or 5,000 kg of CO₂ in a year”; “Did you know the average North American consumes over 700 pounds or 330 kg of paper a year?”; “Did you know the average Western European consumes 440 pounds or 200 kg of paper a year?”; etc.

The foregoing can be introduced as part of a print responsibly campaign. As part of a change management campaign, the user gets an e-mail introduction to the program that introduces print awareness and provides a first mention of print point budget and incentives. When users register, they access getting started screens that provide a brief explanation of widget and an introduction to print point budgeting. Self-assessments are provided, and a monthly e-mail status can be scheduled to provide automated month end summaries to end users. Incentives are provided to reinforce savings behavior, such as donations to rainforest, departmental recognitions, etc.

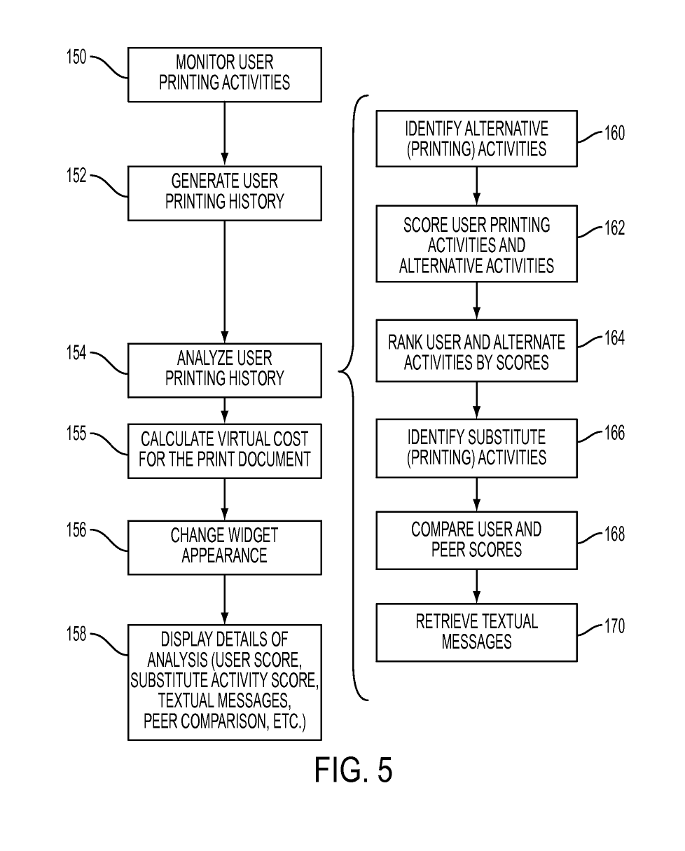

FIG. 5 is flowchart illustrating exemplary methods herein. In item 150, these methods automatically monitor printing activities of a user using a tangible processor. In item 152, such methods automatically analyze the printing activities of the user to determine the printing history of the user over time using the tangible processor.

Also, as shown in item 154, these exemplary methods automatically analyze the printing history of the user by comparing the printing history with previously established printing data (using the tangible processor) to produce an analysis of user printing activity. In item 155, the methods calculate virtual cost for the print document. In item 156, such methods automatically change the appearance (change the size, color, etc.) of a graphic screen item on a graphic user interface based on the analysis of the user printing activity. Further, in item 158, these methods display details of the analysis of user printing activity on the graphic user interface in response to user interaction with the graphic screen item.

When analyzing the printing history of the user in item 154, such methods perform a number of processes. For example, as shown in item 160, these methods identify alternative printing activities that are different from the printing activities of the user (but that produce the same (or identical) printed information as the printing activities of the user, because the alternative printing activities use a different type of printing or different type of output). Further, these methods generate a user score for the printing activities of the user, and generate alternative printing option scores for the alternative printing activities, based on a scoring system corresponding to printer resource consumption (as shown in item 162).

The scoring process utilized in item 162 produces a score that is understandable and meaningful to the user. Rather than presenting the score in units that are hard to conceptualize (such as tons of carbon, kilowatts, pallets of paper, etc.), the scoring process utilizes something that has been artificially made valuable to the user by tying the score to user achievements. In one example, the scoring process scores the user's printing activities by charging printing currency for the printing activity (where the user is also provided a monthly budget of printing currency). In another example, the scoring process scores the users printing activity by incurring activity points (where the user competes with other users in various contests using the activity points).

For example, a user may only be allocated a limited amount of units of printing currency using a budget. By printing in manner that complies with business goals, the user is charged less for printing activities encouraged by the business goals (e.g., draft (reduced toner) printing, monochrome printing, double sided printing, etc.) and is charged more for printing activities that are discouraged by the business goals (e.g., reprints, email printing, web printing, etc.). If a user consistently stays within their printing currency budget (or consistently reduces their printing currency budget) they can be rewarded, and vice versa.

Similarly, the user may accrue activity points for their printing activities. By printing in manner that complies with business goals the user accumulates less activity points for printing activities encouraged by the business goals, and is accumulates more activity points for printing activities that are discouraged by the business goals. Therefore, in this example, a lower point score is a better result. Contests can be established by the business to allow the user to compete with other coworkers, other departments, etc. to see who has the lowest accumulated activity score. Recognition can be made, or prizes can be rewarded, for those who achieve the lowest activity score.

Then, when analyzing the printing history of the user in item 154, such methods compare the user score with the alternative printing option scores to rank the alternative printing activities relative to the printing activities of the user (item 164), and to identify which of the alternative printing activities change the user score the greatest amount (in ranked order) and such alternative printing activities are referred to as substitute printing activities (as shown in item 166).

Further, such methods can compare the user score to scores of peers of the user, to produce a peer comparison, as shown in item 168. Also, when analyzing the printing history of the user in item 154, the methods herein retrieve textural messages of explanation for the substitute printing activities as shown by item 170 (from the previously established printing data, for example). The textural messages of explanation describe why and how using the substitute printing activities change the user score.

Additionally, the scoring system used to calculate the scores in item 162 is established (and can be periodically modified) to achieve specific goals. For example, if it is determined that e-mail printing is a large problem, e-mail printing can be assigned of very high score (10 points per page). Similarly, if web printing is not considered a large problem, it can be assigned a lower score (3 points per page). Additionally, double-sided printing can be assigned relatively lower scores (1 point per page).

When providing the textural messages in item 170, the user is provided specific suggestions to help them reduce their score, and such textural messages can specifically indicate the amount by which their score would be reduced if they change their printing activities. By providing concrete examples of how changing their printing activities would result in a better score (and how much their score would change) the user is highly motivated to change their printing practices. When the users change their printing practices, the results are easily understandable (shown graphically as in FIGS. 1-4) and easily conceptualized by the user (e.g., by changing the amount of printing currency they have, by changing their ranking among their peers, etc.).

Therefore, the methods, systems, and devices herein achieve greater results when attempting to motivate users to change their printing behavior by providing a score that is understandable and meaningful to the user, rather than presenting the score in units that are hard to conceptualize.

While the appearance of the graphic screen item may change based on the analysis in item 154, as shown by item 156, the graphic screen item remains constantly present on the graphic user interface. However, the details of the analysis of user printing activity 154 are displayed on the graphic user interface in item 158 only upon the user interaction with the graphic screen item. Further, when displaying such details of the analysis of user printing activity 154 on the graphic user interface (in response to user interaction with the graphic screen item) in item 158, the methods herein display the user score, the alternative printing option scores of the substitute printing activities in the ranked order, the textural messages, the peer comparison, etc.

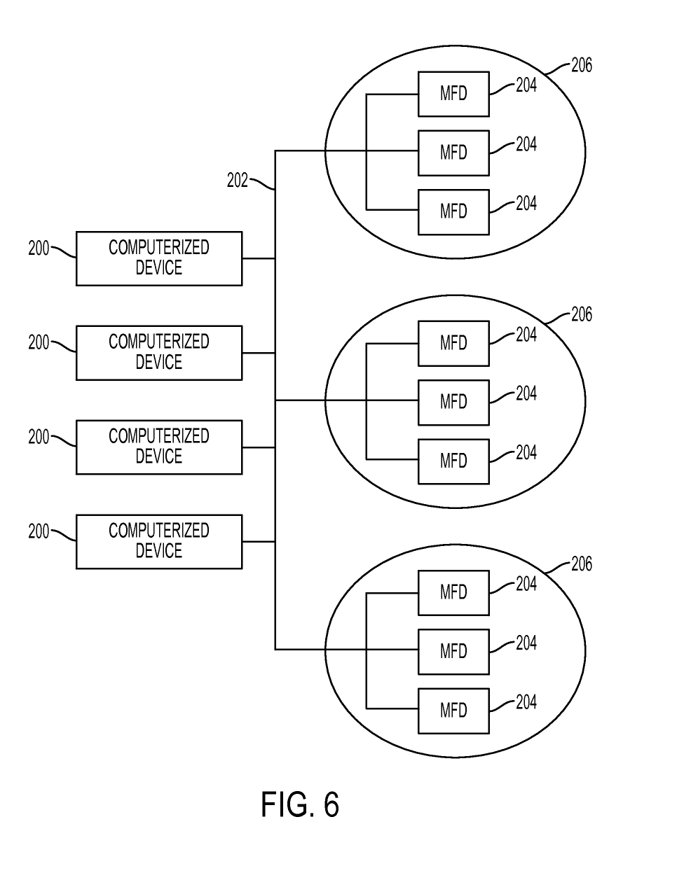

As shown in FIG. 6, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

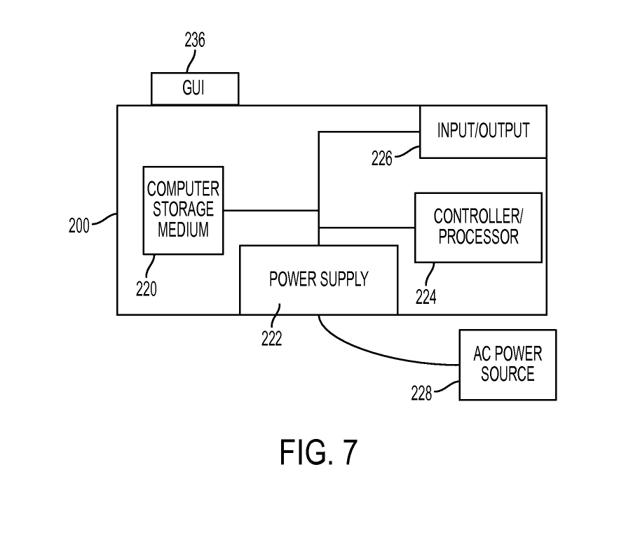

FIG. 7 illustrates a computerized device 200, which can be used with systems and methods herein and can comprise, for example, a print server, a personal computer, a portable computing device, etc. The computerized device 200 includes a controller/tangible processor 224 and a communications port (input/output) 226 operatively connected to the tangible processor 224 and to the computerized network 202 external to the computerized device 200. Also, the computerized device 200 can include at least one accessory functional component, such as a graphic user interface assembly 236 that also operate on the power supplied from the external power source 228 (through the power supply 222).

The input/output device 226 is used for communications to and from the computerized device 200. The tangible processor 224 controls the various actions of the computerized device. A non-transitory computer storage medium device 220 (which can be optical, magnetic, capacitor based, etc.) is readable by the tangible processor 224 and stores instructions that the tangible processor 224 executes to allow the computerized device to perform its various functions, such as those described herein. Thus, as shown in FIG. 7, a body housing has one or more functional components that operate on power supplied from an alternating current (AC) source 228 by the power supply 222. The power supply 222 can comprise a power storage element (e.g., a battery, etc).

Therefore, as shown above, exemplary systems and devices herein automatically monitor printing activities of a user using a tangible processor 224, and automatically analyze the printing activities of the user to generate the printing history of the user over time using the tangible processor 224. Also, these exemplary systems and devices automatically analyze the printing history of the user by comparing the printing history with previously established printing data (using the tangible processor 224) to produce an analysis of user printing activity, and automatically change the appearance (change the size, color, etc.) of a graphic screen item on a graphic user interface 236 (that is operatively (meaning directly or indirectly) connected to the tangible processor 224) based on the analysis of the user printing activity. Further, these systems and devices display details of the analysis of user printing activity on the graphic user interface 236 in response to user interaction with the graphic screen item.

When analyzing the printing history of the user, such systems and devices perform a number of processes. For example, these systems and devices identify alternative printing activities that are different from the printing activities of the user (but that produce the same (or identical) information as the printing activities of the user). Further, these systems and devices generate a user score for the printing activities of the user, and generate alternative printing option scores for the alternative printing activities, based on a scoring system corresponding to printer resource consumption.

Then, such systems and devices compare the user score with the alternative printing option scores to rank the alternative printing activities relative to the printing activities of the user, and to identify which of the alternative printing activities change the user score the greatest amount (in ranked order) and such alternative printing activities are referred to as substitute printing activities. Further, such systems and devices compare the user score to scores of peers of the user, to produce a peer comparison.

Also, when analyzing the printing history of the user, these systems and devices retrieve textural messages of explanation for the substitute printing activities (from the previously established printing data). The textural messages of explanation describe why using the substitute printing activities change the user score.

The graphic screen item remains constantly present on the graphic user interface 236, but the details of the analysis of user printing activity are displayed on the graphic user interface 236 only upon the user interaction with the graphic screen item. Further, when displaying such details of the analysis of user printing activity on the graphic user interface 236 (in response to user interaction with the graphic screen item) the systems and devices herein display the user score, the alternative printing option scores of the substitute printing activities in the ranked order, the textural messages, the peer comparison, etc.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
automatically monitoring printing activities of a user using a tangible processor;
automatically generating a printing history of said user over time based on said printing activities of said user using said tangible processor;
automatically analyzing said printing history of said user by comparing said printing history with previously established printing data using said tangible processor to produce an analysis of user printing activity;
displaying details of said analysis of user printing activity on a graphic user interface operatively connected to said tangible processor,
said analyzing said printing history of said user comprising:
identifying alternative activities that are different from said printing activities of said user;
generating a user score for said printing activities of said user based on a scoring system corresponding to printer resource consumption;
generating alternative option scores for said alternative activities based on said scoring system; and
comparing said user score with said alternative option scores to rank said alternative activities relative to said printing activities of said user, and to identify ones of said alternative activities that change said user score a greatest amount as substitute printing activities in ranked order; and
retrieving textural messages of explanation for said substitute printing activities from said previously established printing data,
said textural messages of explanation describing why using said substitute printing activities change said user score, and
said displaying details of said analysis of user printing activity on said graphic user interface comprising displaying said user score, said alternative option scores of said substitute printing activities in said ranked order, and said textural messages.

2. The method according to claim 1, said comparing said printing history with said previously established printing data further comprising comparing said user score to scores of peers of said user to produce a peer comparison,
said scores of peer of said user being generated using said scoring system, and
said displaying details of said analysis further comprising displaying said peer comparison.

3. The method according to claim 1, said alternative activities producing identical information as said printing activities of said user.

4. The method according to claim 1, further comprising automatically changing at least one of a color and a size of a graphic screen item on said graphic user interface based on said analysis of user printing activity.

5. The method according to claim 4, said graphic screen item remaining constantly present on said graphic user interface, and said displaying details of said analysis of user printing activity being present on said graphic user interface only upon user interaction with said graphic screen item.

6. A method comprising:
automatically monitoring printing activities of a user using a tangible processor;
automatically generating a printing history of said user over time based on said printing activities of said user using said tangible processor;
automatically analyzing said printing history of said user by comparing said printing history with previously established printing data using said tangible processor to produce an analysis of user printing activity;
automatically changing an appearance of a graphic screen item on a graphic user interface operatively connected to said tangible processor based on said analysis of user printing activity; and
displaying details of said analysis of user printing activity on said graphic user interface in response to user interaction with said graphic screen item,
said analyzing said printing history of said user comprising:
identifying alternative printing activities that are different from said printing activities of said user;
generating a user score for said printing activities of said user based on a scoring system corresponding to printer resource consumption;
generating alternative printing option scores for said alternative printing activities based on said scoring system; and
comparing said user score with said alternative printing option scores to rank said alternative printing activities relative to said printing activities of said user, and to identify ones of said alternative printing activities that change said user score a greatest amount as substitute printing activities in ranked order; and
retrieving textural messages of explanation for said substitute printing activities from said previously established printing data,
said textural messages of explanation describing why using said substitute printing activities change said user score, and
said displaying details of said analysis of user printing activity on said graphic user interface in response to user interaction with said graphic screen item comprising displaying said user score, said alternative printing option scores of said substitute printing activities in said ranked order, and said textural messages.

7. The method according to claim 6, said comparing said printing history with said previously established printing data further comprising comparing said user score to scores of peers of said user to produce a peer comparison,
said scores of peer of said user being generated using said scoring system, and
said displaying details of said analysis further comprising displaying said peer comparison.

8. The method according to claim 6, said alternative printing activities producing identical information as said printing activities of said user.

9. The method according to claim 6, said changing said appearance of said graphic screen item on said graphic user interface comprising changing at least one of a color and a size of said graphic screen item.

10. The method according to claim 6, said graphic screen item remaining constantly present on said graphic user interface, and said displaying details of said analysis of user printing activity being present on said graphic user interface only upon said user interaction with said graphic screen item.

11. A computerized device comprising:
a tangible processor automatically monitoring printing activities of a user, said processor automatically generating a printing history of said user over time based on said printing activities of said user, and said processor automatically analyzing said printing history of said user by comparing said printing history with previously established printing data to produce an analysis of user printing activity; and
a graphic user interface operatively connected to said tangible processor,
said graphic user interface displaying details of said analysis of user printing activity,
said analyzing said printing history of said user by said processor comprising:
identifying alternative activities that are different from said printing activities of said user;
generating a user score for said printing activities of said user based on a scoring system corresponding to printer resource consumption;
generating alternative option scores for said alternative activities based on said scoring system; and
comparing said user score with said alternative option scores to rank said alternative activities relative to said printing activities of said user, and to identify ones of said alternative activities that change said user score a greatest amount as substitute printing activities in ranked order; and
retrieving textural messages of explanation for said substitute printing activities from said previously established printing data,
said textural messages of explanation describing why using said substitute printing activities change said user score, and
said displaying details of said analysis of user printing activity by said graphic user interface comprising displaying said user score, said alternative option scores of said substitute printing activities in said ranked order, and said textural messages.

12. The computerized device according to claim 11, said comparing said printing history with said previously established printing data further comprising comparing said user score to scores of peers of said user to produce a peer comparison,
said scores of peer of said user being generated using said scoring system, and
said displaying details of said analysis further comprising displaying said peer comparison.

13. The computerized device according to claim 11, said alternative activities producing identical information as said printing activities of said user.

14. The computerized device according to claim 11, said graphic user interface automatically changing at least one of a color and a size of a graphic screen item on said graphic user interface based on said analysis of user printing activity.

15. The computerized device according to claim 14, said graphic screen item remaining constantly present on said graphic user interface, and said displaying details of said analysis of user printing activity being present on said graphic user interface only upon user interaction with said graphic screen item.

16. A computerized device comprising:
a tangible processor automatically monitoring printing activities of a user, said processor automatically generating a printing history of said user over time based on said printing activities of said user, and said processor automatically analyzing said printing history of said user by comparing said printing history with previously established printing data to produce an analysis of user printing activity; and
a graphic user interface operatively connected to said tangible processor,
said graphic user interface automatically displaying a graphic screen item,
said graphic user interface automatically changing an appearance of said graphic screen item based on said analysis of user printing activity,
said graphic user interface displaying details of said analysis of user printing activity in response to user interaction with said graphic screen item,
said analyzing said printing history of said user by said processor comprising:
identifying alternative printing activities that are different from said printing activities of said user;
generating a user score for said printing activities of said user based on a scoring system corresponding to printer resource consumption;
generating alternative printing option scores for said alternative printing activities based on said scoring system; and
comparing said user score with said alternative printing option scores to rank said alternative printing activities relative to said printing activities of said user, and to identify ones of said alternative printing activities that change said user score a greatest amount as substitute printing activities in ranked order; and
retrieving textural messages of explanation for said substitute printing activities from said previously established printing data,
said textural messages of explanation describing why using said substitute printing activities change said user score, and
said displaying details of said analysis of user printing activity by said graphic user interface in response to user interaction with said graphic screen item comprising displaying said user score, said alternative printing option scores of said substitute printing activities in said ranked order, and said textural messages.

17. The computerized device according to claim 16, said comparing said printing history with said previously established printing data further comprising comparing said user score to scores of peers of said user to produce a peer comparison,
said scores of peer of said user being generated using said scoring system, and
said displaying details of said analysis further comprising displaying said peer comparison.

18. The computerized device according to claim 16, said alternative printing activities producing identical information as said printing activities of said user.

19. The computerized device according to claim 16, said changing said appearance of said graphic screen item on said graphic user interface comprising changing at least one of a color and a size of said graphic screen item.

20. The computerized device according to claim 16, said graphic screen item remaining constantly present on said graphic user interface, and said displaying details of said analysis of user printing activity being present on said graphic user interface only upon said user interaction with said graphic screen item.
